(19) United States
(12) Patent Application Publication
(10) Pub. No.: US 2013/0251878 A1
(43) Pub. Date: Sep. 26, 2013

(54) FOAMING TEA COMPOSITIONS

(71) Applicant: Deepak Sahai, Dublin, OH (US)

(72) Inventor: Deepak Sahai, Dublin, OH (US)

(73) Assignee: NESTEC S.A., Vevey (CH)

(21) Appl. No.: 13/992,169

(22) PCT Filed: Dec. 7, 2011
(86) PCT No.: PCT/EP2011/072071

§ 371 Date: Jun. 6, 2013

Related U.S. Application Data
(60) Provisional application No. 61/420,680, filed on Dec. 7, 2010.

(51) Int. Cl. A23F 3/16

(52) U.S. Cl. CPC A23F 3/163
USPC 426/569

(57) ABSTRACT

The present invention relates to a simple foaming tea composition with a viscosity, clarity or color of the original tea. In one aspect, the invention relates to a foaming tea composition comprising a tea product, a food grade ester alginate, wherein the addition of ester alginate generates or produces a layer of foam upon the tea product when subjected to agitation without also producing a significant change in viscosity, clarity or color of the tea product. In some embodiments, the ester alginate is a synthetic ester alginate, such as propylene glycol alginate ester. In some embodiments, the ester alginate comprises from about 0.01% to about 0.25%, and preferably from about 0.05% to about 0.1% of the foaming tea composition. The present invention also relates to a method of making a foaming tea composition by combining a tea product with an alginate ester.

### TECHNICAL FIELD

The present invention relates to foaming tea composition which includes a tea product and a food grade additive that generates or produces a layer of foam upon the tea product when subjected to agitation without also producing a significant change in viscosity, clarity or color of the tea product. The additive is preferably an ester alginate.

### BACKGROUND

Foamed beverage products comprise a large part of the beverage industry with beer, coffee and cola as well known examples. In fact, much work has been done to enhance the foaming properties of these beverages, through both mechanical and additive means. For example, mechanical whipping machines on both the industrial and personal level are used to aid in the production of froth or foam in cappuccinos and can be found in many coffee shops and homes throughout the world. Various additives such as dairy products and proteins, dissolved gasses, and colloids have been included to enhance the foaming properties of beverages. These often require large amounts of additives, which can over-complicate, and become large amounts of the total beverage, reducing the amount of the beverage's original makeup. A consumer in today's market is also looking for fewer additives and preservatives in products, in an attempt live healthier lifestyles.

U.S. Patent Application Publication No. 2006/0051483 describes a foaming agent prepared from a tea leaf extract. This foaming agent is known to be rich in catechin components. Those components are surface active molecules that may be able to improve foam stability in a beverage, but in commercial use, instant tea powders or tea extracts contain at most only about 30% catechins, because their highly astringent taste limits their use at higher concentrations. This catechin concentration is insufficient to support foaming when tea powders or extracts are used at levels typical for formulating a tea beverage (<0.05%). Thus, for a true foaming tea product, a further additive that improves foaming is needed.

U.S. Pat. No. 5,980,969 describes a foamed tea product that includes alginate as a thickening agent and requires a creaming agent. This patent discloses that the tea concentrate should consist of three essential elements: a powdered tea, a sweetening agent and a creaming agent. The creaming agent is responsible for whitening the foamed beverage. Polysaccharide thickeners including alginate are not essential and may be consider as an optional ingredient. The creaming agent contains dairy proteins or caseinates as with a non-dairy creamer. Due to the known surface active nature of these protein molecules, they are likely to support foaming.

In addition, the specific foam characteristics of a foaming beverage are important. Foams with loose, large bubbles that dissipate too soon are considered poor foams and displeasing to the consumer. Conversely, foams with tiny bubbles that do not dissipate for long periods are also considered poor foams, preventing the user from enjoying the beverage without waiting long periods of time, or forcing the user to consume large quantities of gaseous foam in order to ingest the beverage.

Teas, in general, have poor foaming properties. As such, foamed tea beverages do not encompass a significant portion in the beverage industry. Most foaming tea beverages available require the addition of dairy or other additives, in order to produce the foamed product. As a result, these foaming teas are more viscous and have color and/or appearance changes from the tea from which they are produced. Thus, there exists a need for a foamed tea product that has the viscosity, clarity, and color to that of the original tea, but that also produces a pleasing foam that does not dissipate too soon or last too long. Further, there exists a demand in today's market for foamed tea based products with fewer additives in an attempt live healthier lifestyles. The present invention now resolves this need.

### SUMMARY OF THE INVENTION

The present invention now provides the consumer with a simple foaming tea composition with a viscosity, clarity, and color of the original tea. In one aspect, the invention relates to a foaming tea composition comprising a tea product and a food grade ester alginate in an amount sufficient to generate or produce a layer of foam on the tea product without the addition of other foaming agents when the tea product is subjected to agitation and without also producing a significant change in viscosity, clarity or color of the tea product.

In some embodiments, the ester alginate is a synthetic ester alginate, such as propylene glycol alginate ester. In some embodiments, the ester alginate comprises from about 0.01% to about 0.25% and preferably from about 0.05% to about 0.1% of the foaming tea composition.

In some embodiments, the tea product includes a tea extract, concentrate, granulate, solid, powder, syrup, liquid or a combination thereof.

In some embodiments, the foaming tea composition further comprises diluents such as water, seltzer, or club soda.

In some embodiments, the tea product includes green tea, black tea, oolong tea, white tea, or a combination thereof.

In some embodiments, the foaming tea composition consists essentially of about 99.75% to about 99.95% tea product, and about 0.05% to about 0.25% propylene glycol alginate. In other embodiments, the foaming tea composition consists of those two components.

According to various embodiments, a method for preparing foaming tea composition is described. The method comprises combining a tea product and a food grade ester alginate in an amount sufficient to generate or produce a layer of foam on the tea product without the addition of other foaming agents and agitating the alginate containing tea product to generate or produce a layer of foam upon the tea product without also causing a significant change in viscosity, clarity or color of the tea product.

In some embodiments of the method the combining includes whipping, mixing, agitating, shaking, stirring or beating of the tea product and the alginate ester.

In some embodiments of the method the process further includes hydrating the ester alginate in a solution prior to combining with the tea product.

In some embodiments of the method, the ester alginate is hydrated by the tea product during the combination step.

In some embodiments of the method the tea product is formed by the extraction, dehydration, concentration, grinding, granulating, solidifying, powdering, brewing, steeping or a combination thereof of a tea.

According to various embodiments, the use of a food grade ester alginate to provide a layer of foam upon a tea composition is described. The use is characterized in that the alginate is included in a tea product and the alginate containing tea product is agitated to form the layer of foam upon the tea product without causing a significant change in viscosity, clarity or color of the tea product.

### BRIEF DESCRIPTION OF THE DRAWINGS

Preferred embodiments of the invention, specifically a foaming tea composition can be observed by reviewing the following detailed description and appended drawing figures, wherein:

FIG. 1 is a chart providing the foaming characteristics of foaming tea compositions in accordance with embodiments of the invention.

FIG. 2 is a chart providing the foaming characteristics of a foaming tea composition in accordance with another embodiment of the invention.

### DETAILED DESCRIPTION OF THE INVENTION

The present invention relates to a foaming tea composition comprising a tea product and a food grade ester alginate wherein the addition of ester alginate generates or produces a layer of foam upon the tea product when subjected to agitation without also producing a significant change in viscosity, clarity or color of the tea product. The foaming tea composition uses few or even no additives in order to produce a foaming tea composition with tea characteristics similar to the original tea.

As used herein, “tea product” refers to a tea composition made wholly of tea. The tea product can be 100% tea, steeped from tea leaves, comprising the natural liquid levels of the steeped tea. Alternatively, the tea product can be a tea extract, concentrate, granulate, solid, powder, or syrup made from steeped tea leaves. Thus, in this instance, the tea product contains lower levels of liquid—or has an absence of any liquids. The tea product can include the tea of a single tea variety, or a mixture of one or more tea varieties. The tea product can be filtered or may contain natural sediment. The tea product can be pasteurized.

As used herein, “viscosity” refers to a measure of the resistance of the tea product or tea composition being deformed by either shear stress or tensile stress. In other words, viscosity refers to the “thickness” or “thinness” of the tea or tea composition. The foaming tea composition should have a viscosity that is similar to a steeped tea or the desired viscosity of a reconstituted tea product. If the tea product is made from 100% steeped tea, then the foamed tea composition should have a similar viscosity to the steeped tea. Alternatively, if a tea product is a granulate and is hydrated to a specific viscosity prior to forming the foaming tea composition, the foaming tea composition should have a similar viscosity to the hydrated tea product. Viscosity can be measured using a viscometer or rheometer, as known in the art. Viscosity can be described in units of “μ” or “η,” as known in the art.

As used herein, “clarity” refers to the opaqueness or cloudiness of the tea or tea composition. The foaming tea composition should have a clarity that is similar to a steeped tea product or the desired viscosity of a reconstituted tea product. If the tea product is made from 100% steeped black tea, then the foamed tea composition should have a similar clarity to the steeped black tea. Alternatively, if a tea product is a granulate, and is hydrated to a specific clarity prior to forming the foaming tea composition, the foaming tea composition should have a similar clarity to the hydrated tea product. A foamed tea composition should not be significantly clearer or cloudier compared to the original tea product.

As used herein, “color” refers to the hue of the tea product or tea composition. The foaming tea composition should have a color that is similar to a steeped tea product or the color of a reconstituted tea product. If a tea product is subsequently altered with a food grade dye or pigment, then the foamed tea composition should have the color of the dyed tea product. The color of a foamed tea composition should be similar to the original tea product. The color of the tea product or foamed tea composition may be measured using a colorimeter in order to provide a quantifiable measurement, as known in the art.

As used herein, “similar” refers to limited differences between a physical characteristic of the tea product and the foamed tea composition. If a physical characteristic, such as viscosity, clarity or color has a specific quantifiable measurement, that measurement should be the same, or nearly the same, between the tea product (steeped or hydrated) and the foamed tea composition. Some amount of variation is permitted. Preferably, a quantifiable measurement, such as viscosity should not have more than a 20% difference between the tea product and the foamed tea composition. More preferably, a quantifiable measurement should not have more than a 10% difference between the tea product and the foamed tea composition. Even more preferable, a quantifiable measurement should not have more than less than about a 5% difference between the tea product and the foamed tea composition. Alternatively, a tea product with a brown color, should not result in a foamed tea composition with a white color. Slight changes with respect to shades of a color may be permitted.

As used herein “significant” refers to large differences between a physical characteristic of the tea product of foamed tea composition. If a physical characteristic, such as viscosity, clarity or color has a specific quantifiable measurement, that measurement should be the same, or nearly the same, between the tea product (steeped or hydrated) and the foamed tea composition. There should not be a significant difference between the two measurements. Some amount of variation is permitted. Preferably, a quantifiable measurement, having more than a 20% difference between the tea product and the foamed tea composition would be considered a “significant” difference. More preferably, a quantifiable measurement having more than a 10% difference between the tea product and the foamed tea composition would be considered a “significant” difference. Even more preferable, a quantifiable measurement having more than about a 5% difference between the tea product and the foamed tea composition would be considered a “significant” difference. Alternatively, a starting tea product with a thin viscosity similar to water would be considered significantly different than a final foamed tea composition having a thick viscosity similar to honey. Likewise, a starting tea product with a brown color would be considered significantly different than a final foamed tea composition having a white color.

As used herein, “comprising,” “is,” “are,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

A surprising feature of the foaming tea composition is the relative simplicity and limited number of the ingredients of the foaming tea composition. The compositions may consist essentially of or even consist of a tea product and a food grade ester alginate. The foaming tea composition can contain from about 1% to about 99.99% by weight of the tea product. Preferably, the foaming tea composition can contain from about 75% to about 99.99% by weight of the tea product. Most preferably, the foaming tea composition can contain from about 99.75% to about 99.99% by weight of the tea product. Conversely, the foaming tea composition can contain about 0.01% to about 0.25% by weight of the food grade ester alginate. Preferably, the foamed tea composition can comprise from about 0.05% to about 0.1% ester alginate.

As mentioned above, the tea product can be 100% steeped tea or can be a tea extract, concentrate, granulate, solid, powder, or syrup made from non-concentrated tea. The tea product can include the tea of one or more varieties. The tea varieties that can be used in the tea product can include, but is not limited to, green tea, black tea, oolong tea, rooibos tea, white tea, or a combination thereof.

The foaming properties of the foaming tea composition are derived from the presence of food grade ester alginates. Alginates or alginic acid can be natural or synthetic. Sources of natural alginates can be derived from seaweeds such as Ascophyllum, Durvillaea, Ecklonia, Laminaria, Lessonia, Macrocystis, Sargassum and Turbinaria. Synthetic alginates include propylene glycol alginate. Preferably, the food grade ester alginate is propylene glycol alginate ester (PGAE) (Supplier: FMC Biopolymers, Philadelphia, Pa.). One or more alginate esters may be used in a foaming tea composition.

Esterification occurs at the carboxylic acid groups on the alginate chain, mainly with the primary hydroxyl group. Depending on reaction conditions, varying degrees of esterification can be achieved. The food grade ester alginate may be about 60 to 70% esterified, but may be up to about 90% esterified depending upon the fruit tea composition and the desired foaming characteristics of the fruit tea composition.

The ester alginate can be provided in powdered form and may be hydrated prior to combination with the tea product, or may be hydrated by the tea product. Alternatively, the ester alginate may be partially hydrated prior to combination with the tea product, and only fully hydrated when combined with the tea product. A skilled artisan would be able to determine the required hydration of the ester alginate, depending upon the desired final foamed tea composition.

In some embodiments, the foamed tea composition can include diluents separate from the tea product or the alginate ester. The diluents can be, but are not limited to, water and carbonated beverages, such as club soda or seltzer. The addition of diluents should not significantly alter the foaming properties. For certain embodiments, the sole source of water in the foamed tea composition may possibly be derived from the water present in the steeped tea itself or alternatively, the sole source of water may comprise added water.

The temperature of the foamed tea composition can vary. For example, the foamed tea composition can be served as a hot or cold beverage. In some embodiments, the tea product or the diluent can be heated prior to combination with the alginate ester. In alternate embodiments, the tea product or the diluent can be heated after combination with the alginate ester. Additionally, the foamed tea product can be a cold or chilled beverage. In these embodiments, the tea product or the diluent can be heated prior to combination with the alginate ester, and the foamed tea product can subsequently be chilled over ice to produce a cold beverage. Alternatively, the tea product or the diluent can be chilled or refrigerated prior to combination with the alginate ester to produce a cold beverage.

The use of alginates in the food industry has been generally known for years and alginates in particular are often used for their stabilization, and thickening properties in beverages. It was a surprising discovery that low quantities of ester alginates alone, i.e., without being combined with other foaming agents, are capable of producing foamed tea compositions without altering the viscosity, clarity, or color of the foamed tea product in comparison to the initial non-alginate containing tea product.

Aqueous mixtures of tea products in graduated (i.e., measured) flasks, cylinders, or tubes, with or without 0.1% by weight of PGAE or other hydrocolloids, can be tested for foaming characteristics. Using commercially available whipping or mixing machines, aqueous mixtures can be mechanically foamed. Noting the height of the aqueous mixture prior to mixing, and comparing it to the height of the top of the foam after mixing, one can determine a “whippability index” for the foamed tea product. The “whippability index” is the air to liquid ratio of the foamed composition. A foamed tea composition having a whippability index above of at least 0.3% or greater and preferably about 0.4% to 0.5% or higher would be considered to be a foamable tea composition.

The stability of the foam can also be measured. Once foamed, the duration of the foam head, (i.e., how long the foam lasts on top of the tea) can be timed. An aqueous mixture subjected to whipping can be set aside and left undisturbed for a period of time. Preferably, the foam is measured in one minute (60 second) intervals. Foams that are able to be maintained for more than several minutes are considered to be a foamable tea composition. Foams that immediately deflate within the first minute are considered to be poor foamable tea compositions.

Because the foaming capability of the foamed tea compositions is derived from food grade alginate esters, the act of foaming can be made using any suitable mechanical agitation. For example, the foam can be produced by agitating a mixture of the tea product and the alginate ester by whipping, mixing, agitating, shaking, stirring or beating the aqueous mixture. The mixing can be done using impellers, blades, discs, paddles, or high pressure streams of the liquid(s). The mixing can occur in whipping chambers, in-cup mixers, or even in packaging containing the premixed ingredients. For example, the foaming tea product can be dispensed from conventional food service machines using high pressure spray nozzles that eject the tea product and the alginate ester into a container or cup to produce the foamed tea composition.

The mixing of the foamed tea composition can be done with the tea product and alginate ester mixed together prior to foaming. Alternatively, the foamed tea composition can be made by first foaming the tea product, then foaming the alginate ester, and then combining the two foamed products. It was surprising and unexpected that a higher quality foam is produced by combining the tea product and the alginate ester prior to foaming versus foaming the individual components, and then combining.

In some embodiments, the foamed tea compositions can be distributed as a ready-to-drink composition with appropriate packaging. Such packaging would allow the foaming tea composition to not foam until ready to be consumed, by separating the tea product from the ester alginate until immediately prior to consumption, at which time the user applies agitation to the product to produce the foam. In alternate embodiments, the act of opening the sealed packaging provides sufficient agitation to produce the foam. In another embodiment, pouring or spraying the aqueous mixture containing the tea product and alginate ester into a container, such as a glass or cup provides sufficient agitation to produce the foam. In alternate embodiments, the mixture of tea product and ester alginate is distributed via airtight pressurized aluminum containers. Such containers may be pressurized with gasses such as carbon dioxide or nitrogen. The foaming composition is then agitated sufficiently as it is dispensed via a tap or a spigot.

In another embodiment, the foamed tea compositions can be distributed as individual components (a tea product and an alginate ester) to be mixed locally by the end user in a food service machine. In such embodiments, the tea product may be distributed as a concentrate (granulate, powder, syrup, etc.), and the alginate ester can be distributed as a concentrate (granulate, powder, syrup, gel, etc.). The end user can then dilute the tea product and the alginate ester appropriately, provide the required agitation and produce the foamed tea composition. Such separate packing can be integrated into standard food service machines found in offices and homes alike. Further, individual packets can be distributed to consumers, which allows a user to dilute the tea concentrate and alginate ester in an appropriate amount of diluents (such as the water in an individual water bottle), mix the ingredients appropriately and form the tea product. Thus, the tea composition may be distributed in cans, jars, bottles, boxes, kegs, packets or other means known in the art.

### EXAMPLES

The following examples are given by way of illustration only and are not intended to limit the scope of the invention in any way.

### Example 1

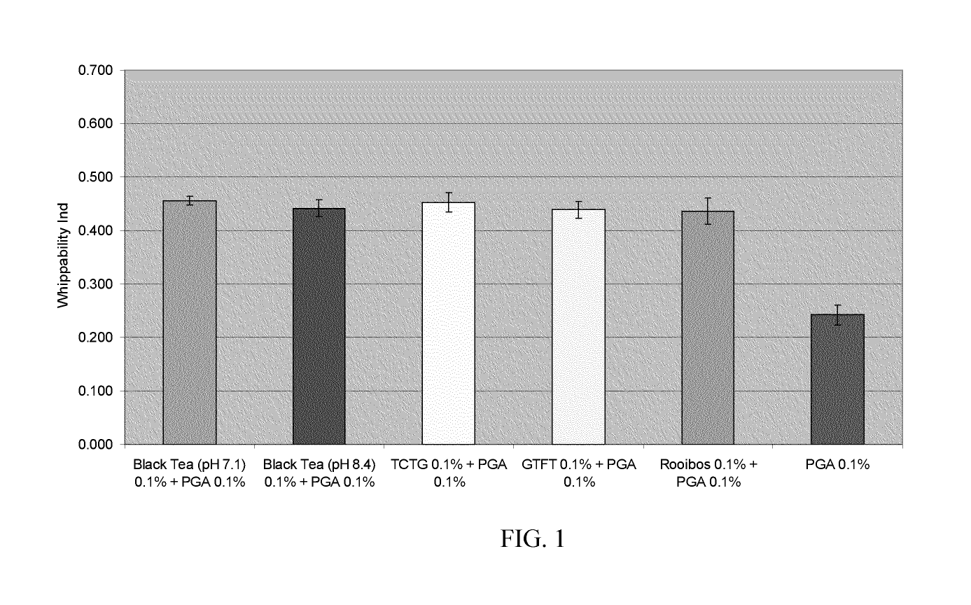

Tests determining the foaming characteristics of various teas for their foaming capabilities is presented in FIG. 1 and Table 1 below.

TABLE 1

| Tea | Alginate Ester |
|---|---|
| Black Tea (pH 7.1) | 0.1% PGAE |
| Black Tea (pH 8.4) | 0.1% PGAE |
| Instant Green Tea (TCTG) | 0.1% PGAE |
| Instant Green Tea (GTFT) | 0.1% PGAE |
| Rooibos Tea | 0.1% PGAE |
| None (control) | 0.1% PGAE |

100 mLs of aqueous mixtures of 100% tea with 0.1% PGAE was dispensed into a graduated cylinder (250 ml) through a beverage dispenser with a whipper such that the beverage was whipped at 5000 rpm for 15 seconds while dispensing The height of the aqueous mixture was measured pre- and post-whipping and used to calculate the “whippability” index. The whipped mixture was allowed to stand undisturbed and the foam height was recorded after 1 and 5 minutes to observe foam stability. As can be seen in FIG. 1, all compositions having a tea and 0.1% by weight PGAE showed significant foaming characteristics. Conversely, 0.1% PGAE in solution alone failed to produce a significant foam.

### Example 2

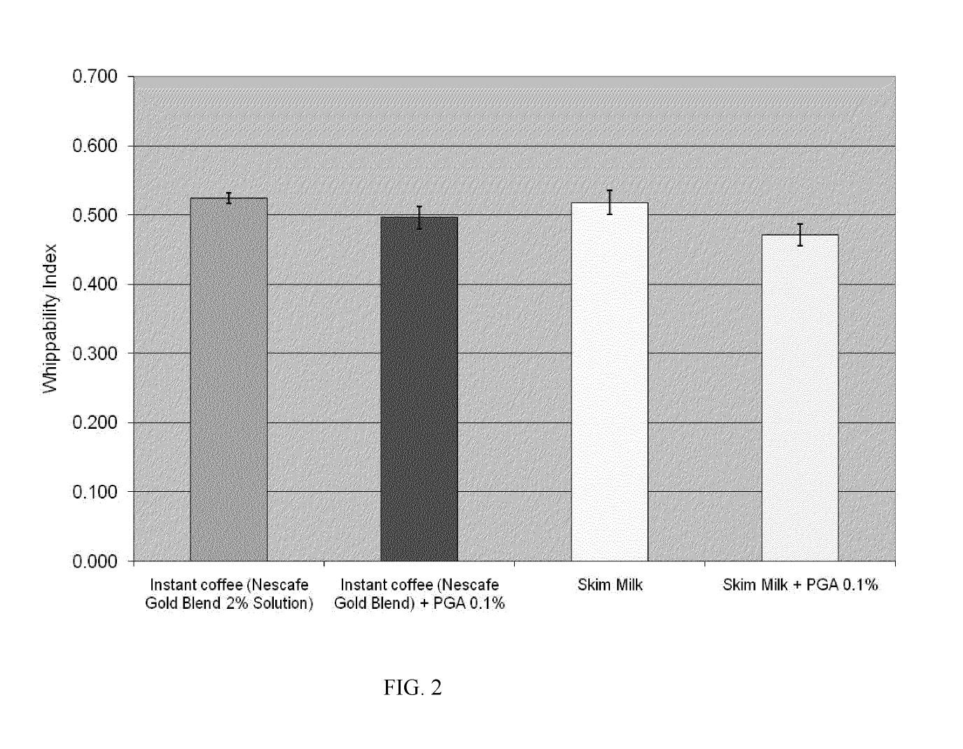

shows the surprising result that not all beverages can be foamed using low amounts of PGAE is presented in FIG. 2 and Table 2 below.

TABLE 2

| Beverage | Alginate Ester |
|---|---|
| Instant Coffee (Nescafe Gold Blend) | 0.1% PGAE |
| Skim milk | 0.1% PGAE |

100 mLs of aqueous mixtures of 100% instant coffee (2% solution) with 0.1% PGAE were prepared in a beaker. The mixture was dispensed into a graduated cylinder (250 ml) through a beverage dispenser with a whipper such that the beverage was whipped at 5000 rpm for 15 seconds while dispensing. The height of the aqueous mixture was measured pre- and post-whipping in a graduated cylinder (250 ml) to calculate the whippability Index. The whipped mixture was allowed to stand undisturbed and the volume of the foam measured after 1 and 5 minutes to observe foam stability. As can be seen in FIG. 2, all compositions having a tea and 0.1% by weight PGAE showed significant foaming characteristics. Conversely, tests on coffee as well as skim milk show that the addition of PGAE was incapable of producing an improvements in the suitable foamed composition. Further tests supported this observation in that similar results were found for other beverages.

It was surprising to discover that low amounts of alginate esters were capable of producing superior foaming capabilities to tea products. It was even more surprising that the combination of tea product and alginate ester produces a better quality foam than if one foams the tea product separately from the alginate ester, and then mixes them together, suggesting a synergistic relationship. It was also surprising and unexpected that the addition of other constituents into the compositions could render the aqueous mixture of tea product and alginate ester incapable of foaming. It was even more surprising and unexpected that not all liquid beverages were capable of being foamed. As such, the addition of other constituents should be test for their effects on the foaming characteristics of the tea composition.

Various additives may be included in the aqueous mixture of the tea product and the alginate ester. For example, food grade dyes, flavorants, preservatives, sweeteners, etc., may be added into the mixture. Further, the aqueous mixtures can be fortified with vitamins, minerals, antioxidants, probiotics, or prebiotics, etc. The foaming tea composition can be caffeinated or decaffeinated. However, appropriate amounts and concentrations of the additives must be tested in order to determine their additive effect on the foaming properties of the composition. A skilled artisan, using the techniques described herein, would be able to produce such foaming tea compositions.

While illustrative aspects in accordance with the present invention are disclosed herein, it will be appreciated that numerous modifications and other embodiments can be devised by those of ordinary skill in the art. The aspects described herein can be combined, separated, interchanged, and/or rearranged to generate other embodiments. Therefore, it will be understood that the appended claims are intended to cover all such modifications and embodiments that come within the spirit and scope of the present invention. Many variations and modifications will be apparent to those of ordinary skill in the art.

1. A foaming tea composition comprising:
a tea product; and
a food grade ester alginate in an amount sufficient to generate or produce a layer of foam thereon without the addition of other foaming agents when subjected to agitation without also producing a significant change in viscosity, clarity or color of the tea product.

2. The foaming tea composition of claim 1, wherein the ester alginate is a synthetic ester alginate and the composition has a whippability index of at least 0.3.

3. The foaming tea composition of claim 1, wherein the ester alginate comprises about 0.01% to about 0.25% of the foaming tea composition.

4. The foaming tea composition of claim 1, wherein the tea product includes a component selected from the group consisting of a tea extract, concentrate, granulate, solid, powder, syrup, liquid and combinations thereof.

5. The foaming tea composition of claim 1, comprising a diluent.

6. The foaming tea composition of claim 1, wherein the tea product includes a tea selected from the group consisting of black tea, oolong tea, white tea, and combinations thereof.

7. The foaming tea composition of claim 1, consisting essentially of about 99.75% to about 99.9% tea product, and about 0.05% to about 0.25% propylene glycol alginate.

8. A process of making a foaming tea composition, comprising:
combining a food grade ester alginate with a tea product, wherein the alginate is added in an amount sufficient to generate or produce a layer of foam thereon without the addition of other foaming agents when the tea product is subjected to agitation; and
agitating the alginate containing tea product to generate or produce a layer of foam thereon without also causing a significant change in viscosity, clarity or color of the tea product.

9. The process of claim 8, wherein the combining includes a step selected from the group consisting of whipping, mixing, agitating, shaking, stirring, and beating of the tea product and the alginate ester.

10. The process of claim 8, wherein the process includes hydrating the ester alginate in a solution prior to combining with the tea product.

11. The process of claim 8, wherein the ester alginate is hydrated by the tea product during the combination step.

12. The process of claim 8, wherein the tea product is formed by a step selected from the group consisting of extraction, dehydration, concentration, grinding, granulating, solidifying, powdering, brewing, steeping, and combinations thereof, of a tea.

13. The process of claim 8, wherein the ester alginate is a synthetic ester alginate.

14. The process of claim 8, wherein the ester alginate comprises from about 0.01% to about 0.25% of the foaming tea composition.

15. The process of claim 8, wherein the tea product includes a component selected from the group consisting of a tea extract, concentrate, granulate, solid, powder, syrup, liquid and combinations thereof.

16. A method for providing a layer of foam upon a tea composition, comprising adding a food grade ester alginate to a tea product in an amount sufficient to produce a layer of foam thereon without the addition of other foaming agents and subjecting the tea product to agitation to form the layer of foam upon the tea product without causing a significant change in viscosity, clarity or color of the tea product.
